(19) United States
(12) Patent Application Publication
(10) Pub. No.: US 2018/0035367 A1
(43) Pub. Date: Feb. 1, 2018

(54) Method and Apparatus for Accessing Wifi Access Point in Target Shop

(71) Applicant: Baidu Online Network Technology (Beijing) Co., Ltd., Beijing (CN)

(72) Inventor: Fan Wang, Beijing (CN)

(73) Assignee: Baidu Online Network Technology (Beijing) Co., Ltd., Beijing (CN)

(21) Appl. No.: 15/425,223

(22) Filed: Feb. 6, 2017

(30) Foreign Application Priority Data
Jul. 28, 2016 (CN) 201610615500.5

(51) Int. Cl. H04W 48/16; H04W 12/06

(52) U.S. Cl. CPC H04W 48/16; H04W 12/06; H04W 84/12

(57) ABSTRACT

An object of the present invention is to provide a method and apparatus for accessing a WiFi access point in a target shop. Specifically, the method comprises obtaining WiFi information of a target shop corresponding to geographical location information of the user's mobile device, wherein the WiFi information comprises a WiFi password of the target shop, and the user has reservation information of the target shop; providing the WiFi information to the user; obtaining the user's selection operation for the WiFi information to duplicate the WiFi password; in response to the selection operation, providing a corresponding WiFi password input box to the user so that the user pastes the WiFi password in the WiFi password input box to access the WiFi access point corresponding to the target shop.

### CROSS-REFERENCE TO RELATED APPLICATION

This application claims the priority of Chinese Patent Application No. 201610615500.5, entitled “Method and Apparatus for Accessing WiFi Access Point in Target Shop,” filed on Jul. 28, 2016, the content of which is incorporated herein by reference in its entirety.

### TECHNICAL FIELD

The present invention relates to the technical field of the Internet, and particularly to a technology for accessing a WiFi access point in a target shop.

### BACKGROUND

Prevalence of WiFi (Wireless-Fidelity) technology greatly facilities our access to a network. For example, when a user dines at a restaurant or goes shopping at a store, he usually uses a WiFi access point in the shop to browse online. At this time, the user usually needs to ask the shop assistant for a password and manually enter the password, but this approach is less efficient. Alternatively, the password is obtained through APP (Application)-based WiFi password sharing, but this approach causes hidden risks to user's private information and the password is less precise.

### SUMMARY

An object of the present invention is to provide a method and apparatus for accessing a WiFi access point in a target shop.

According to an aspect of the present invention, there is provided a method of accessing a WiFi access point in a target shop, wherein the method comprises:

obtaining WiFi information of a target shop corresponding to geographical location information of a mobile device of a user, wherein the WiFi information comprises a WiFi password of the target shop, and the user has reservation information of the target shop;

providing the WiFi information to the user;

obtaining a selection operation of the user for the WiFi information to duplicate the WiFi password;

in response to the selection operation, providing a corresponding WiFi password input box to the user so that the user pastes the WiFi password in the WiFi password input box to access the WiFi access point corresponding to the target shop.

According to an aspect of the present invention, there is provided an apparatus of accessing a WiFi access point in a target shop, wherein the access apparatus comprises:

means for obtaining WiFi information of a target shop corresponding to geographical location information of a mobile device of a user, wherein the WiFi information comprises a WiFi password of the target shop, and the user has reservation information of the target shop;

means for providing the WiFi information to the user;

means for obtaining a selection operation of the user for the WiFi information to duplicate the WiFi password;

means for, in response to the selection operation, providing a corresponding WiFi password input box to the user so that the user pastes the WiFi password in the WiFi password input box to access the WiFi access point corresponding to the target shop.

As compared with the prior art, in the present disclosure, the WiFi password of the user's group purchase shop is directly provided to the user he plans to enter the shop, it may be directly duplicated during the user's access to the WiFi, and then the password input box is launched, and the user does not need to memorize and manually input the password. This provides convenient operation, improves the user's efficiency in obtaining the WiFi password of the shop and boosts the user's WiFi access experience.

### BRIEF DESCRIPTION OF THE DRAWINGS

Other features, objectives and advantages of the present disclosure will be made more apparent by reading through detailed description of unrestrictive embodiments with reference to the following figures.

FIG. 1 illustrates a block diagram of an apparatus for accessing a WiFi access point in a target shop according to one aspect of the present disclosure;

FIGS. 2(a)-2(e) illustrate a schematic diagram of a procedure of accessing a WiFi access point in a target shop according to an embodiment of the present disclosure; and

FIG. 3 illustrates a flow chart of a method for accessing a WiFi access point in a target shop according to another aspect of the present disclosure.

Identical or like reference signs in figures denote identical or similar parts.

### DETAILED DESCRIPTION OF EMBODIMENTS

The present disclosure will be described in more detail with reference to figures.

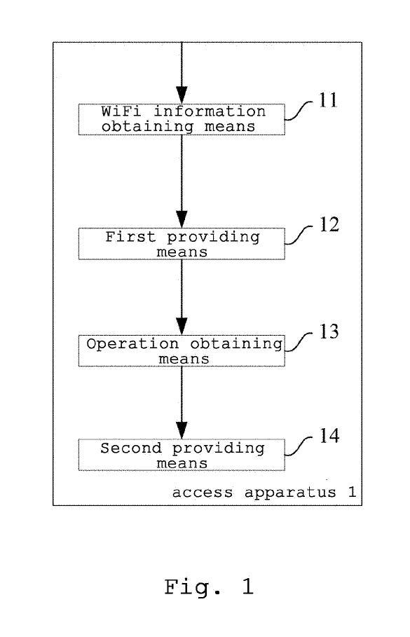

FIG. 1 illustrates a block diagram of an access apparatus 1 for accessing a WiFi access point in a target shop according to one aspect of the present disclosure, wherein the access apparatus 1 comprises means (hereinafter referred to as “WiFi information obtaining means 11”) for obtaining WiFi information of a target shop corresponding to geographical location information of the user's mobile device, wherein the WiFi information comprises a WiFi password of the target shop, and the user has reservation information of the target shop; means (hereinafter referred to as “a first providing means 12”) for providing the WiFi information to the user; means (hereinafter referred to as “an operation obtaining means 13”) for obtaining the user's selection operation for the WiFi information to duplicate the WiFi password; means (hereinafter referred to as “second providing means 14”) for, in response to the selection operation, providing a corresponding WiFi password input box to the user so that the user pastes the WiFi password in the WiFi password input box to access the WiFi access point corresponding to the target shop.

Specifically, the WiFi information obtaining means 11 obtains WiFi information of a target shop corresponding to geographical location information of the user's mobile device, wherein the WiFi information includes a WiFi password of the target shop, and the user has reservation information of the target shop; the first providing means 12 provides the WiFi information to the user; the operation obtaining means 13 obtains the user's selection operation for the WiFi information to duplicate the WiFi password; the second providing means 14, in response to the selection operation, provides a corresponding WiFi password input box to the user so that the user pastes the WiFi password in the WiFi password input box to access the WiFi access point corresponding to the target shop.

Here, the access apparatus 1 comprises, but is not limited to, a network device, mobile device or an apparatus formed by integrating a network device with a user equipment through a network. Hence, the network device comprises, but is not limited, to network host machine, a single network server, a set of multiple network servers, or a computer set based on cloud computing; or implemented by a mobile device. Here, cloud is comprised of a lot of host machines or network servers based on cloud computing, wherein cloud computing is a kind of distributed computing and is a super virtual computer comprised of a group of loosely-coupled computer sets. Here, the mobile device may be any type of electronic product capable of performing human-machine interaction with the user via a keyboard, a touch panel, a touch screen, a hand write device or the like, for example, a mobile phone, a smart phone, a PDA, a wearable device, a palm computer PPC or a tablet computer. The network comprises but is not limited to the Internet, a wide area network, a metropolitan area network, a local area network, a VPN network, and a wireless Ad hoc network. Those skilled in the art should appreciate that the above access apparatus 1 is only an example. Other network devices or mobile devices that are currently existing or might occur in the future are adapted for the present invention, should be included in the protection scope of the present invention, and are included herein by reference. Here, the network device and mobile device both comprise an electronic device capable of automatically performing numerical value computing and information processing according to a preset or stored instruction, and its hardware comprise but is not limited to a microprocessor, an application-specific integrated circuit (ASIC), a field programmable gate array (FPGA), a digital signal processor (DSP), an embedded device and the like.

Specifically, the WiFi information obtaining means 11 first obtains geographical position information (for example, geographical coordinates, or geodetic coordinates or the like) of the user's mobile device through for example a radio communication network (such as GSM network or CDMA network) of a telecommunication mobile operator or in an external positioning manner (e.g. GPS). Next, determines which shop's reservation information the user has according to shops on the geographical location information and in conjunction with communication identification information of the user's mobile device (here, the communication identification information is used to solely identify the mobile device such as the user's mobile phone number). Next, queries from a shop WiFi password database to obtain the WiFi information of the target shop, wherein the WiFi information comprises the WiFi password of the target shop and the user has reservation information of the target shop. Here, the WiFi information may further comprise a WiFi name of the target shop. Herein, the reservation information of the target shop comprises but is not limited to a group purchase order uncompleted by the user at the target shop (e.g. unused, or already used but not completed).

For example, suppose the user A carries a mobile device with him and is located at a geographical location B, the WiFi information obtaining means 11 first obtains geographical position information of the geographical location B where the user A is located through for example a radio communication network (such as GSM network or CDMA network) of a telecommunication mobile operator or in an external positioning manner (e.g. GPS), for example, geographical coordinates (39° N, 115° E) of the geographical location B. Next, the WiFi information obtaining means 11 determines which shop's reservation information the user has according to shops on the geographical location information and in conjunction with a communication identification information of the user's mobile device (e.g. the user's mobile phone number). For example, suppose there are shops p1, p2 and p3 at the geographical location B, and the user A's mobile phone number is 13800331111, the WiFi information obtaining means 11 may, based on a group purchase table of each shop, determine the user A has reservation information of which shop among the three shops, for example, determine that the user A has an uncompleted group purchase order of shop p1. Next, the WiFi information obtaining means 11 queries from the shop WiFi password database to obtain the WiFi information of shop p1, for example, obtain that the WiFi password of shop P1 is 12345678.

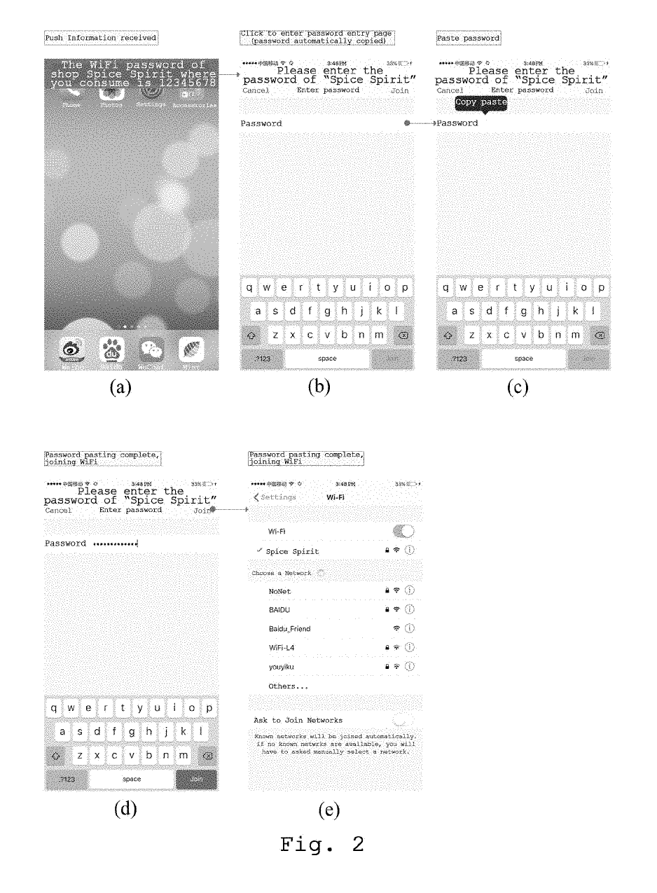

The first providing means 12 provides the WiFi information to the user. For example, suppose that the name of shop 1 is “Spice Spirit”, the first providing means 12 may send the WiFi password of the shop p1 to the user A via a short message, as shown in FIG. 2(a).

Next, the operation obtaining means 13, via for example an application program interface (API) provided by the mobile device, obtains a selection operation of the user for the WiFi information to duplicate the WiFi information. Here, the selection operation comprises but is not limited to select, click and the like. For example, again referring to the above example, suppose the user A clicks short message shown in FIG. 2(a), the operation obtaining means 13 may obtain the clicking operation executed by the user A.

Those skilled in the art should appreciate that the above selection operation is only exemplary, other selection operations that are currently existing or might occur in the future are adapted for the present invention, should be included in the protection scope of the present invention, and are included herein by reference.

Next, the second providing means 14, in response to the selection operation, provides a corresponding WiFi password input box to the user so that the user pastes the WiFi password in the WiFi password input box to access the WiFi access point corresponding to the target shop. For example, again referring to the above example, after the user A clicks the short message shown in FIG. 2(a), the second providing means 14, in response to the clicking operation, provides a corresponding WiFi password input box to the user A so that as shown in FIG. 2(b), the user A pastes the WiFi password “12345678” in the WiFi password input box to access the WiFi access point corresponding to the shop “Spice Spirit”. The specific procedure is as shown in FIGS. 2(c)-2(e).

Preferably, the access apparatus 1 further comprises means (hereinafter referred to as “detecting means”, not shown) for detecting whether a detection condition of providing the WiFi information to the user is satisfied. Specifically, the detecting means detects whether a detection condition of providing the WiFi information to the user is satisfied. If the detection condition is satisfied, the first providing means 12 provides the WiFi information to the user.

Specifically, the detecting means detects whether a detection condition of providing the WiFi information to the user is satisfied. If the detection condition is satisfied, the first providing means 12 provides the WiFi information to the user. Preferably, the detection condition comprises at least any one of the following: the mobile device enters the target group purchase shop; a distance between the mobile device and the target group purchase shop satisfies a predetermined condition; the mobile device enters a WiFi coverage area of the target group purchase shop.

For example, when the user A consumes in the group purchase shop p1, and the mobile device carried by him enters the shop, the detecting means detects that a detection condition of providing the WiFi information of shop p1 to the user A is satisfied, and at this time, the first providing means 12 provides the WiFi password of shop p1 to the user A. For another example, if the detection condition is that a distance between the mobile device and the target group purchase shop satisfies a predetermined condition, for example, when the user A is about 20 m away from the shop p1, the detection condition of providing the WiFi information to the user A is satisfied, and at this time, the first providing means 12 provides the WiFi password of shop p1 to the user A.

Those skilled in the art should appreciate that the above detection conditions are only an examples, other detection conditions that are currently existing or might occur in the future are adapted for the present invention, should be included in the protection scope of the present invention, and are included herein by reference.

In a preferred embodiment (referring to FIG. 1), the WiFi information obtaining means 11 comprises a unit (hereinafter referred to as “a candidate determining unit”; not shown) for, based on communication identification information of the mobile device, determining one or more candidate group purchase shops corresponding to the user correlated to the mobile device, wherein the user has reservation information of the candidate group purchase shop; a unit (hereinafter referred to as “a target determining unit”; not shown) for, based on the geographical location information of the mobile device, determining, from the one or more candidate group purchase shops, a target shop corresponding to the geographical location information; and a unit (hereinafter referred to as “an obtaining unit”; not shown) for obtaining the WiFi information of the target shop.

Specifically, the candidate determining unit, based on the communication identification information of the mobile device, determines one or more candidate group purchase shops corresponding to the user correlated to the mobile terminal, wherein the user has reservation information of the candidate group purchase shop.

For example, as for the user A, suppose he participates in group purchase of shops p1, d2 and d3, the candidate determining unit may, based on the communication identification information (e.g. mobile phone number) of the mobile device of the user A, perform a matching query in a group purchase information database to obtain shops whose group purchase is participated in by the user A, namely, shops p1, d2 and d3, and regard them as the candidate group purchase shops, wherein the group purchase information database includes a mapping relationship between the communication identification information of the user's mobile device and the candidate group purchase shops.

Next, the target determining unit, based on the geographical location information of the mobile device, determines, from the one or more candidate group purchase shops, a target shop corresponding to the geographical location information, for example, considers a candidate group purchase shop whose geographical location is consistent with the geographic location of the mobile device as a target shop. For example, referring to the above example, suppose the geographical location information of shop p1 is consistent with the geographical location of the user's mobile device while shops d2 and d3 are inconsistent with the geographical location of the user A's mobile device, the target determining unit only considers the shop p1 as the target shop.

Next, the obtaining unit obtains the WiFi information of the target shop, for example, it may, based on an identifier of the target shop, perform a matching query in the database to obtain its WiFi information.

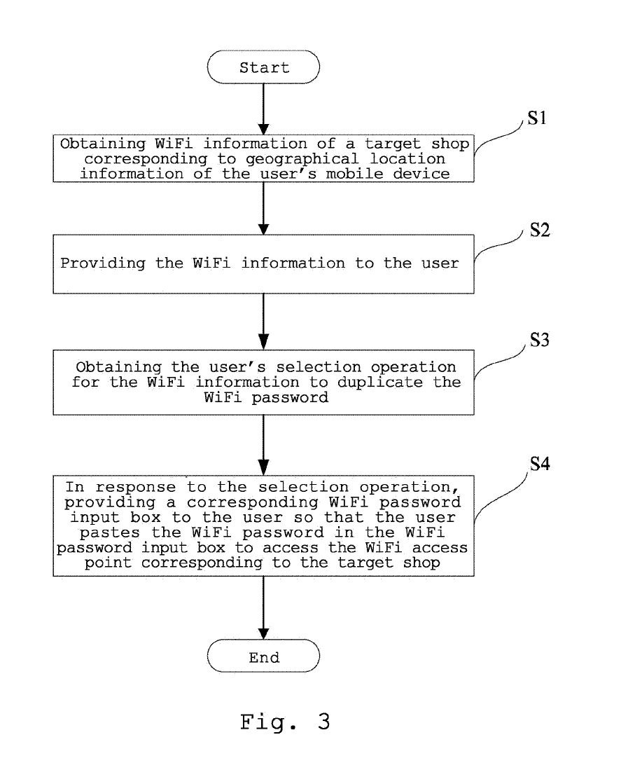

FIG. 3 illustrates a flow chart of a method for accessing a WiFi access point in a target shop according to another aspect of the present disclosure.

The method comprises step S1, step S2, step S3 and step S4. Specifically, at step S1, the access apparatus 1 obtains WiFi information of a target shop corresponding to geographical location information of the user's mobile device, wherein the WiFi information includes a WiFi password of the target shop, and the user has reservation information of the target shop. At step S2, the access apparatus 1 provides the WiFi information to the user. At step S3, the access apparatus 1 obtains the user's selection operation for the WiFi information to duplicate the WiFi password. At step S4, the access apparatus 1, in response to the selection operation, provides a corresponding WiFi password input box to the user so that the user pastes the WiFi password in the WiFi password input box to access the WiFi access point corresponding to the target shop.

Here, the access apparatus 1 comprises but is not limited to a network device, mobile device or an apparatus formed by integrating a network device with a user equipment through a network. Hence, the network device comprises but is not limited to network host machine, a single network server, a set of multiple network servers, or a computer set based on cloud computing; or implemented by a mobile device. Here, cloud is comprised of a lot of host machines or network servers based on cloud computing, wherein cloud computing is a kind of distributed computing and is a super virtual computer comprised of a group of loosely-coupled computer sets. Here, the mobile device may be any type of electronic product capable of performing human-machine interaction with the user via a keyboard, a touch panel, a touch screen, a hand write device or the like, for example, a mobile phone, a smart phone, a PDA, a wearable device, a palm computer PPC or a tablet computer. The network comprises but is not limited to the Internet, a wide area network, a metropolitan area network, a local area network, a VPN network, and a wireless Ad hoc network. Those skilled in the art should appreciate that the above access apparatus 1 is only an example. Other network devices or mobile devices that are currently existing or might occur in the future are adapted for the present invention, should be included in the protection scope of the present invention, and are included herein by reference. Here, the network device and mobile device both comprise an electronic device capable of automatically performing numerical value computing and information processing according to a preset or stored instruction, and its hardware comprise but is not limited to a microprocessor, an application-specific integrated circuit (ASIC), a field programmable gate array (FPGA), a digital signal processor (DSP), an embedded device and the like.

Specifically, at step S1, the access apparatus 1 first obtains geographical position information (for example, geographical coordinates, or geodetic coordinates or the like) of the user's mobile device through for example a radio communication network (such as GSM network or CDMA network) of a telecommunication mobile operator or in an external positioning manner (e.g. GPS). Next, determines which shop's reservation information the user has according to shops on the geographical location information and in conjunction with communication identification information of the user's mobile device (here, the communication identification information is used to solely identify the mobile device such as the user's mobile phone number). Next, queries from a shop WiFi password database to obtain the WiFi information of the target shop, wherein the WiFi information comprises the WiFi password of the target shop and the user has reservation information of the target shop. Here, the WiFi information may further comprise a WiFi name of the target shop. Here, the reservation information of the target shop comprises but is not limited to a group purchase order uncompleted by the user at the target shop (e.g. unused, or already used but not completed).

For example, suppose the user A carries a mobile device with him and is located at a geographical location B, at step S1, the access apparatus 1 may first obtain geographical position information of the geographical location B where the user A is located through for example a radio communication network (such as GSM network or CDMA network) of a telecommunication mobile operator or in an external positioning manner (e.g. GPS), for example, geographical coordinates (39° N, 115° E) of the geographical location B. Next, at step S1, the access apparatus 1 determines which shop's reservation information the user has according to shops on the geographical location information and in conjunction with a communication identification information of the user's mobile device (e.g. the user's mobile phone number). For example, suppose there are shops p1, p2 and p3 at the geographical location B, and the user A's mobile phone number is 13800331111, at step S1, the access apparatus 1 may, based on a group purchase table of each shop, determine the user A has reservation information of which shop among the three shops, for example, determine that the user A has an uncompleted group purchase order of shop p1. Next, at step S1, the access apparatus 1 queries from the shop WiFi password database to obtain the WiFi information of shop p1, for example, obtain that the WiFi password of shop P1 is 12345678.

In step S2, the access apparatus 1 provides the WiFi information to the user. For example, suppose that the name of shop 1 is “Spice Spirit”, at step S2, the access apparatus 1 may send the WiFi password of the shop p1 to the user A via a short message, as shown in FIG. 2(a).

Next, at step S3, the access apparatus 1, via for example an application program interface (API) provided by the mobile device, obtains the user's selection operation for the WiFi information to duplicate the WiFi information. Here, the selection operation comprises but is not limited to select, click and the like. For example, again referring to the above example, suppose the user A clicks short message shown in FIG. 2(a), at step S3, the access apparatus 1 may obtain the clicking operation executed by the user A.

Those skilled in the art should appreciate that the above selection operation is only exemplary, other selection operations that are currently existing or might occur in the future are adapted for the present invention, should be included in the protection scope of the present invention, and are included herein by reference.

Next, at step S4, the access apparatus 1, in response to the selection operation, provides a corresponding WiFi password input box to the user so that the user pastes the WiFi password in the WiFi password input box to access the WiFi access point corresponding to the target shop. For example, again referring to the above example, after the user A clicks the short message shown in FIG. 2(a), at step S4, the access apparatus 1, in response to the clicking operation, provides a corresponding WiFi password input box to the user A so that as shown in FIG. 2(b), the user A pastes the WiFi password “12345678” in the WiFi password input box to access the WiFi access point corresponding to the shop “Spice Spirit”. The specific procedure is as shown in FIGS. 2(c)-2(e).

Preferably, the method further comprises step S5 (not shown). Specifically, at step S5, the access apparatus 1 detects whether a detection condition of providing the WiFi information to the user is satisfied. If the detection condition is satisfied, at step S2, the access apparatus 1 provides the WiFi information to the user.

Specifically, at step S5, the access apparatus 1 detects whether a detection condition of providing the WiFi information to the user is satisfied. If the detection condition is satisfied, at step S2, the access apparatus 1 provides the WiFi information to the user. Preferably, the detection condition comprises at least any one of the following: the mobile device enters the target group purchase shop; a distance between the mobile device and the target group purchase shop satisfies a predetermined condition; the mobile device enters a WiFi coverage area of the target group purchase shop.

For example, when the user A consumes in his group purchase shop p1, and the mobile device carried by him enters the shop, at step S5, the access apparatus 1 detects that a detection condition of providing the WiFi information of shop p1 to the user A is satisfied, and at this time, at step S2, the access apparatus 1 provides the WiFi password of shop p1 to the user A. For another example, if the detection condition is that a distance between the mobile device and the target group purchase shop satisfies a predetermined condition, for example, when the user A is about 20 m away from the shop p1, the detection condition of providing the WiFi information to the user A is satisfied, and at this time, at step S2, the access apparatus 1 provides the WiFi password of shop p1 to the user A.

Those skilled in the art should appreciate that the above detection conditions are only examples, other detection conditions that are currently existing or might occur in the future are adapted for the present invention, should be included in the protection scope of the present invention, and are included herein by reference.

In a preferred embodiment (referring to FIG. 3), step S1 includes step S11 (not shown), step S12 (not shown) and step S13 (not shown). Specifically, at step S11, the access apparatus 1, based on communication identification information of the mobile device, determines one or more candidate group purchase shops corresponding to the user correlated to the mobile device, wherein the user has reservation information of the candidate group purchase shop; at step S12, the access apparatus 1, based on the geographical location information of the mobile device, determines, from the one or more candidate group purchase shops, a target shop corresponding to the geographical location information; at step S13, the access apparatus 1 obtains the WiFi information of the target shop.

Specifically, at step S11, the access apparatus 1, based on the communication identification information of the mobile device, determines one or more candidate group purchase shops corresponding to the user correlated to the mobile terminal, wherein the user has reservation information of the candidate group purchase shop.

For example, as for the user A, suppose he participates in group purchase of shops p1, d2 and d3, at step S11, the access apparatus 1 may, based on the communication identification information (e.g. mobile phone number) of the mobile device of the user A, performs a matching query in a group purchase information database to obtain shops whose group purchase is participated in by the user A, namely, shops p1, d2 and d3, and regards them as the candidate group purchase shops, wherein the group purchase information database includes a mapping relationship between the communication identification information of the user's mobile device and the candidate group purchase shops.

Next, at step S12, the access apparatus 1, based on the geographical location information of the mobile device, determines, from the one or more candidate group purchase shops, a target shop corresponding to the geographical location information, for example, considers a candidate group purchase shop whose geographical location is consistent with the geographic location of the mobile device as a target shop. For example, referring to the above example, suppose the geographical location information of shop p1 is consistent with the geographical location of the user's mobile device while shops d2 and d3 are inconsistent with the geographical location of the user A's mobile device, at step S12, the access apparatus 1 only considers the shop p1 as the target shop.

Next, at step S13, the access apparatus 1 obtains the WiFi information of the target shop, for example, it may, based on an identifier of the target shop, perform a matching query in the database to obtain its WiFi information.

It should be noted that the present invention may be implemented in software and/or a combination of software and hardware, for example, implemented by an application-specific integrated circuit (ASIC), a general purpose computer or any other similar hardware devices. In one embodiment, the software program of the present invention may be executed by a processor to perform the above steps or functions. Likewise, the software program of the present invention (including the relevant data structure) may be stored in a computer-readable recording medium, e.g. RAM memory, magnetic or optical driver or soft floppy disk or a similar device. Additionally, some steps or functions of the present invention may be implemented using hardware, e.g. as a circuit cooperating with the processor to perform various functions or steps.

In addition, a portion of the present invention may be applied as a computer program product, e.g. a computer program instruction. When it is executed by the computer, a method and/or technical solution according to the present invention may be invoked or provided through operations of the computer. The program instruction for invoking the method of the present invention may be stored in a stationary or movable recording medium, and/or transmitted via data stream in broadcast or other signal bearing media, and/or stored in a working memory of a computer device running according to the program instruction. Here, an embodiment according to the present invention includes a device which includes a memory for storing the computer program instruction and a processor for executing the program instruction, wherein when the computer program instruction is executed by the processor, the device is triggered to run the method and/or technical solution in a plurality of embodiments according to the present invention.

For those skilled in the art, it is obvious that the present invention is not limited to the details of the above exemplary embodiments, and the present invention can be implemented in other specific forms without departing from the spirit or basic features of the present invention. Therefore, in any way, the embodiments shall be regarded as exemplary rather than limiting; the scope of the present invention is limited by the appended claims, instead of the above description. Thus, all variations which fall into the meaning and scope of equivalent elements of the claims shall be covered within the present invention. No reference signs in the claims shall be regarded as limiting the involved claims. Besides, it is obvious that the term “comprise” does not exclude other units or steps, and singularity does not exclude plurality. A plurality of units or means set forth in a system claim may also be implemented by a single unit or means through software or hardware. Terms such as first and second are used to indicate names, but do not indicate any particular sequence.

What is claimed is:

1. A method for accessing a WiFi access point in a target shop, the method comprising:
obtaining WiFi information of a target shop corresponding to geographical location information of a mobile device of a user, wherein the WiFi information comprises a WiFi password of the target shop, and the user has reservation information of the target shop;
providing the WiFi information to the user;
obtaining a selection operation of the user for the WiFi information to duplicate the WiFi password;
in response to the selection operation, providing a corresponding WiFi password input box to the user so that the user pastes the WiFi password in the WiFi password input box to access the WiFi access point corresponding to the target shop.

2. The method according to claim 1, wherein the obtaining WiFi information of a target shop corresponding to geographical location information a mobile device of a user comprises:
determining one or more candidate group purchase shops corresponding to the user correlated to the mobile device based on communication identification information of the mobile device, wherein the user has reservation information of the candidate group purchase shops;
determining, from the one or more candidate group purchase shops, a target shop corresponding to the geographical location information, based on the geographical location information of the mobile device; and
obtaining the WiFi information of the target shop.

3. The method according to claim 2, wherein the determining one or more candidate group purchase shops corresponding to the user comprises:
performing a matching query in a group purchase information database to obtain one or more candidate group purchase shops corresponding to the user based on the communication identification information of the mobile device of the user, wherein the user has reservation information of the candidate group purchase shop, and the group purchase information database includes a mapping relationship between the communication identification information of the mobile device of the user and the candidate group purchase shops.

4. The method according to claim 1, wherein the method further comprises:
detecting whether a detection condition of providing the WiFi information to the user is satisfied;
wherein the providing the WiFi information to the user comprises:
if the detection condition is satisfied, providing the WiFi information to the user.

5. The method according to claim 4, wherein the detection condition comprises at least one of the following:
the mobile device enters the target shop;
a distance between the mobile device and the target shop satisfies a predetermined condition; and
the mobile device enters a WiFi coverage area of the target shop.

6. An access apparatus for accessing a WiFi access point in a target shop, the access apparatus comprising:
means for obtaining WiFi information of a target shop corresponding to geographical location information of a mobile device of a user, wherein the WiFi information comprises a WiFi password of the target shop, and the user has reservation information of the target shop;
means for providing the WiFi information to the user;
means for obtaining a selection operation of the user for the WiFi information to duplicate the WiFi password;
means for, in response to the selection operation, providing a corresponding WiFi password input box to the user so that the user pastes the WiFi password in the WiFi password input box to access the WiFi access point corresponding to the target shop.

7. The access apparatus according to claim 6, wherein means for obtaining WiFi information of a target shop corresponding to geographical location information of a mobile device of a user comprises:
a unit for determining one or more candidate group purchase shops corresponding to the user correlated to the mobile device based on communication identification information of the mobile device, wherein the user has reservation information of the candidate group purchase shops;
a unit for determining, from the one or more candidate group purchase shops, a target shop corresponding to the geographical location information, based on the geographical location information of the mobile device; and
a unit for obtaining the WiFi information of the target shop.

8. The access apparatus according to claim 7, wherein the unit for determining one or more candidate group purchase shops corresponding to the user is configured to:
perform a matching query in a group purchase information database to obtain one or more candidate group purchase shops corresponding to the user based on the communication identification information of a mobile device of the user, wherein the user has reservation information of the candidate group purchase shop, and the group purchase information database includes a mapping relationship between the communication identification information of a mobile device of the user and the candidate group purchase shops.

9. The access apparatus according to claim 6, wherein the access apparatus further comprises:
means for detecting whether a detection condition of providing the WiFi information to the user is satisfied;
wherein the means for providing the WiFi information to the user is configured to:
if the detection condition is satisfied, provide the WiFi information to the user.

10. The access apparatus according to claim 9, wherein the detection condition comprises at least any one of the following:
the mobile device enters the target shop;
a distance between the mobile device and the target shop satisfies a predetermined condition;
the mobile device enters a WiFi coverage area of the purchase shop.

11. A non-transitory computer storage medium storing a computer program, which when executed by one or more processors, cause the one or more processors to perform operations, the operations comprising:
obtaining WiFi information of a target shop corresponding to geographical location information of a mobile device of a user, wherein the WiFi information comprises a WiFi password of the target shop, and the user has reservation information of the target shop;
providing the WiFi information to the user;
obtaining a selection operation of the user for the WiFi information to duplicate the WiFi password;
in response to the selection operation, providing a corresponding WiFi password input box to the user so that the user pastes the WiFi password in the WiFi password input box to access the WiFi access point corresponding to the target shop.

12. The non-transitory computer storage medium according to claim 11, wherein the obtaining WiFi information of a target shop corresponding to geographical location information a mobile device of a user comprises:
determining one or more candidate group purchase shops corresponding to the user correlated to the mobile device based on communication identification information of the mobile device, wherein the user has reservation information of the candidate group purchase shops;
determining, from the one or more candidate group purchase shops, a target shop corresponding to the geographical location information, based on the geographical location information of the mobile device; and
obtaining the WiFi information of the target shop.

13. The non-transitory computer storage medium according to claim 12, wherein the determining one or more candidate group purchase shops corresponding to the user comprises:
performing a matching query in a group purchase information database to obtain one or more candidate group purchase shops corresponding to the user based on the communication identification information of the mobile device of the user, wherein the user has reservation information of the candidate group purchase shop, and the group purchase information database includes a mapping relationship between the communication identification information of the mobile device of the user and the candidate group purchase shops.

14. The non-transitory computer storage medium according to claim 11, the operations further comprising:
detecting whether a detection condition of providing the WiFi information to the user is satisfied;
wherein the providing the WiFi information to the user comprises:
if the detection condition is satisfied, providing the WiFi information to the user.

15. The non-transitory computer storage medium according to claim 14, wherein the detection condition comprises at least one of the following:
the mobile device enters the target shop;
a distance between the mobile device and the target shop satisfies a predetermined condition; and
the mobile device enters a WiFi coverage area of the target shop.
